(19) United States
(12) Patent Application Publication
(10) Pub. No.: US 2008/0312789 A1
(43) Pub. Date: Dec. 18, 2008

(54) Control Device for Operating a Motor Vehicle, and Method for Operating a Motor Vehicle

(76) Inventor: Ivaylo Frankov, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/093,760

(22) PCT Filed: Oct. 19, 2006
(86) PCT No.: PCT/EP2006/067567

§ 371 Date: Jul. 23, 2008

(30) Foreign Application Priority Data
Nov. 21, 2005 (DE) 10 2005 055 757.0

(51) Int. Cl. G06F 7/00

(52) U.S. Cl. 701/36

(57) ABSTRACT

A control device for a motor vehicle is used to store authorization data for drivers and driving times in which operation of the motor vehicle is meant to be possible. The control device is connected to an electronic engine immobilizer (6) which disables or enables operation of the motor vehicle on the basis of the stored data. This means that the motor vehicle can be started up only by a particular driver in an intended time period.

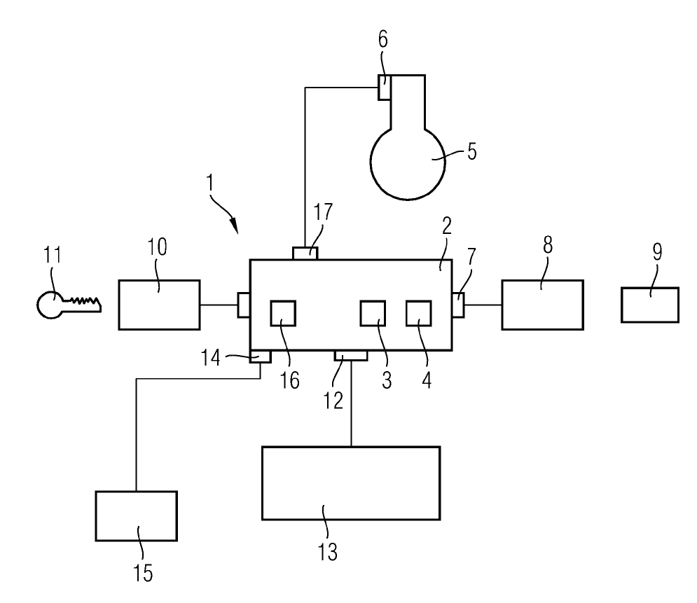

### CROSS-REFERENCE TO RELATED APPLICATIONS

This application is a U.S. national stage application of International Application No. PCT/EP2006/067567 filed Oct. 19, 2006, which designates the United States of America, and claims priority to German application number 10 2005 055 757.0 filed Nov. 21, 2005, the contents of which are hereby incorporated by reference in their entirety.

### TECHNICAL FIELD

The invention relates to a control device for operating a motor vehicle, with at least one detection device for detecting an authorization to operate the motor vehicle, with an electronic memory for authorization data for drivers for operating the motor vehicle, and with means for enabling or blocking operation of the motor vehicle. The invention also relates to a method for operating a motor vehicle, in which personal data for a driver are detected, and operation of the motor vehicle is enabled or blocked after the personal data have been compared with authorization data stored in a memory.

### BACKGROUND

Such a control device with such a method is disclosed, for example, in DE 195 33 515 A1. In this case, the control device is arranged in a tachograph. The detection device reads the authorization data, which relate to the respective driver, from a chip card. If the driver is authorized to operate the motor vehicle, the motor vehicle can be started. However, if the authorization is lacking, operation of the motor vehicle is prevented by intervening in an engine controller.

However, the disadvantage of the known control device is that any person in possession of the chip card can start the motor vehicle and can operate it at any desired times. However, operation of the motor vehicle at any desired times is undesirable, in particular in the case of trucks in a commercial vehicle fleet, since the driver can use the motor vehicle for unintended, mostly private purposes.

Furthermore, theft of the motor vehicle is possible at any time as a result of theft of the chip card.

### SUMMARY

A control device of the type mentioned initially can be developed in such a manner that it makes unauthorized use of the motor vehicle difficult. Furthermore, a method of the type mentioned initially can be developed in such a manner that unauthorized use of the motor vehicle is made difficult.

According to an embodiment, a control device for operating a motor vehicle may comprise at least one detection device for detecting an authorization to operate the motor vehicle, an electronic memory for authorization data for drivers for operating the motor vehicle, means for enabling or blocking operation of the motor vehicle, wherein the memory for the authorization data for the drivers is assigned to a memory for possible driving times in which operation of the motor vehicle is possible for the individual driver, and a computation unit operable to assign the authorization for the drivers to the possible driving times of the individual driver.

According to another embodiment, a method for operating a motor vehicle, in which personal data for a driver are detected, and operation of the motor vehicle is enabled or blocked after the personal data have been compared with authorization data stored in a memory, may comprise the step of assigning the authorization data for the drivers data for driving times in which operation of the motor vehicle by an intended driver is enabled or blocked.

According to a further embodiment, the computation unit may comprise an interface for a navigation device and a memory for regions in which it is possible to operate the motor vehicle, and the computation unit may be operable to assign the authorization for the drivers to regions in which operation of the motor vehicle is intended. According to a further embodiment, the computation unit may have an interface for connection to an electronic data processing system for storing values in the memories. According to a further embodiment, the detection device may have a card reader or an ignition lock of the motor vehicle. According to a further embodiment, the computation unit may have an interface for connection to an electronic immobilizer of the motor vehicle.

### BRIEF DESCRIPTION OF THE DRAWINGS

The invention permits numerous embodiments. In order to further illustrate its basic principle, one of them is illustrated in the drawing and is described below.

The single FIGURE of said drawing shows a control device according to an embodiment for operating a motor vehicle.

### DETAILED DESCRIPTION

According to an embodiment, a memory for the authorization data for the drivers is assigned to a memory for possible driving times in which operation of the motor vehicle is possible for the individual driver, and a computation unit is designed to assign the authorization for the drivers to the possible driving times of the individual driver.

This configuration makes it possible for the authorized driver to start the motor vehicle only at previously determined driving times which are stored in the memory. As a result of this, operation of the motor vehicle for the authorized driver is restricted to the possible driving times which have been stored. Theft or unauthorized operation of the motor vehicle outside the stored driving times is, thus, impossible.

In order to make it more difficult to use the motor vehicle in an unauthorized manner, it helps if, according to one embodiment, the computation unit has an interface for a navigation device and a memory for regions in which it is possible to operate the motor vehicle, and if the computation unit is designed to assign the authorization for the drivers to regions in which operation of the motor vehicle is intended. This configuration makes it possible to define regions which are accessible to the motor vehicle. If the driver of the motor vehicle leaves the region in which operation of the motor vehicle is intended, the means for enabling or operating the motor vehicle can block further operation of the motor vehicle. Alternatively or additionally, an alarm may also be triggered using a radio link.

According to another embodiment, the data stored in the memories may be easily changed if the computation unit has an interface for connection to an electronic data processing system for storing values in the memories. Modern, generally conventional and preferably portable computers are suitable as the data processing system. The interface may optionally have a plug-in contact or may be wireless.

The control device according to an embodiment is designed in a particularly simple manner if the detection device has a card reader and/or an ignition lock of the motor vehicle.

The motor vehicle can be blocked or enabled in various ways, for example by controlling a parking brake or intervening in the engine controller. However, the structural outlay for the control device according to an embodiment can be kept particularly low if the computation unit has an interface for connection to an electronic immobilizer of the motor vehicle. Such electronic immobilizers are generally customary in modern motor vehicles, with the result that the control device according to an embodiment can be easily connected to existing components of the motor vehicle.

A method of the type mentioned initially can be enhanced in such a manner that unauthorized use of the motor vehicle is made difficult, according to a further embodiment, by virtue of the fact that the authorization data for the drivers are assigned data for driving times in which operation of the motor vehicle by an intended driver is enabled or blocked.

This configuration of the method according to an embodiment means that the motor vehicle can only be started when the authorization data for the driver are available and the driver is simultaneously authorized to activate the motor vehicle at the current time. This makes it very difficult to use the motor vehicle in an unauthorized manner. The method can be preferably used to operate the abovementioned control device which is arranged in the motor vehicle.

The control device 1 has a computation unit 2 having a memory 3 for authorization data for a driver of the motor vehicle and a memory 4 for possible driving times in which the individual driver is authorized to use the motor vehicle. The computation unit 2 has an interface 17 for connection to an electronic immobilizer 6 arranged on an internal combustion engine 5 of the motor vehicle. The computation unit 2 also has an interface 7 for a card reader 8. Chip cards 9 which define the identity of the drivers can be inserted into the card reader 8. One chip card 9 is provided for each driver. The computation unit 2 is also connected to an ignition lock 10 for an ignition key 11 of the motor vehicle. It goes without saying that, in an embodiment which is not illustrated, a single component may also be used for an electronic key instead of the card reader 8 and the ignition lock 10. The computation unit 2 also has an interface 12 for an electronic data processing system 13, for example a portable computer. The electronic data processing system 13 can be used to change the memory 4 containing the driving times. Furthermore, the electronic data processing system 13 can be used to read and change the memory 3 for the authorization data. This makes it possible, for example, to release a new chip card 9 for a new driver or, in the event of a chip card 9 being lost, to erase the authorization data on this chip card 9. The computation unit 2 also has an interface 14 for a navigation device 15. The computation unit 2 is designed to evaluate the data in the navigation device 15 and activates the electronic immobilizer 6 if the motor vehicle leaves an intended region. In order to store the intended regions, the computation unit 2 has a memory 16 which can be changed by the data processing system 13.

1. A control device for operating a motor vehicle, comprising at least one detection device for detecting an authorization to operate the motor vehicle, an electronic memory for authorization data for drivers for operating the motor vehicle, means for enabling or blocking operation of the motor vehicle, wherein the memory for the authorization data for the drivers is assigned to a memory for possible driving times in which operation of the motor vehicle is possible for the individual driver, and a computation unit operable to assign the authorization for the drivers to the possible driving times of the individual driver.

2. The control device according to claim 1, wherein the computation unit comprises an interface for a navigation device and a memory for regions in which it is possible to operate the motor vehicle, and wherein the computation unit is operable to assign the authorization for the drivers to regions in which operation of the motor vehicle is intended.

3. The control device according to claim 1, wherein the computation unit has an interface for connection to an electronic data processing system for storing values in the memories.

4. The control device according to claim 1, wherein the detection device has a card reader or an ignition lock of the motor vehicle.

5. The control device according to claim 1, wherein the computation unit has an interface for connection to an electronic immobilizer of the motor vehicle.

6. A method for operating a motor vehicle, in which personal data for a driver are detected, and operation of the motor vehicle is enabled or blocked after the personal data have been compared with authorization data stored in a memory, the method comprising the step of assigning the authorization data for the drivers data for driving times in which operation of the motor vehicle by an intended driver is enabled or blocked.

7. The method according to claim 6, further comprising the step of assigning further authorization data for the drivers to regions in which operation of the motor vehicle is intended.

8. The method according to claim 6, further comprising the step of immobilizing of the motor vehicle in case an authorization failed.

9. A control device for operating a motor vehicle, comprising
at least one detection device for detecting an authorization to operate the motor vehicle by one of a plurality of drivers,
an electronic memory storing authorization data for the plurality of drivers, wherein the authorization data for each driver comprise possible driving times in which operation of the motor vehicle is possible;
a control unit operable to compare said authorization with a respectively stored authorization data.

10. The control device according to claim 9, wherein the control unit comprises an interface for a navigation device and the authorization data further comprise a region in which it is possible to operate the motor vehicle.

11. The control device according to claim 9, wherein the control unit has an interface for connection to an electronic data processing system for storing values in the memories.

12. The control device according to claim 9, wherein the detection device has a card reader or an ignition lock of the motor vehicle.

13. The control device according to claim 9, wherein the control unit has an interface for connection to an electronic immobilizer of the motor vehicle.

14. The control device according to claim 9, wherein the detection device has a card reader and an ignition lock of the motor vehicle.

15. The control device according to claim 1, wherein the detection device has a card reader and an ignition lock of the motor vehicle.
